(19) United States
(12) Patent Application Publication
(10) Pub. No.: US 2003/0027937 A1
(43) Pub. Date: Feb. 6, 2003

(54) Vinycyclohexane-based single layer films

(76) Inventors: Dirk Mockel, Krefeld (DE); Volker Wege, Neuss (DE); Friedrich-Karl Bruder, Krefeld (DE); Konstadinos Douzinas, Koln (DE)

Correspondence Address: BAYER CORPORATION, PATENT DEPARTMENT, 100 BAYER ROAD, PITTSBURGH, PA, 15205, US

(21) Appl. No.: 10/168,641

(22) PCT Filed: Dec. 11, 2000
(86) PCT No.: PCT/EP00/12483

(30) Foreign Application Priority Data
Dec. 22, 1999 (DE) 199 62 018.0

(51) Int. Cl. C08G 63/91

(52) U.S. Cl. 525/410

(57) ABSTRACT

Monofilms containing a vinylcyclohexane-based polymer or a mixture of vinylcyclohexane-based polymers with at least one polar polymer.

This invention relates to a monofilm which is made of a homopolymer or copolymer based on vinylcyclohexane and is distinguished by having low density, high transparency, an excellent water-vapour barrier action as well as good processability.

The demands placed by the market on packaging materials are long-term durability and the maximum possible protection of the packaged goods from disturbing influences, against the background of a trend towards decreasing use of material and inexpensive packaging materials and techniques.

Many goods, such as, for example, foods, electronic articles or pharmaceuticals react, inter alia, sensitively to moisture and must therefore be effectively protected from water vapour.

Besides the properties of permeation through the intact material, which are inherent to the material, important factors affecting the barrier action of a film material are the nature and extent of defects (for example, specks, air pockets and the like), because these can contribute decisively to the unwanted diffusion of gases or of flavouring substances. This is particularly important, as in the thermoforming of a film material, such as, for example, during deep-drawing for the production of blister packaging, the effect of such defects at points on the blister where wall thicknesses are low will be particularly marked.

Films made of PVC, polypropylene, cycloolefin copolymers and polystyrene which have water-vapour barrier properties are known.

PVC films are often used as packaging materials for moisture-sensitive goods. As the water-vapour barrier action of pure PVC is often inadequate, these films are additionally coated with polyvinylidene chloride. Halogen-containing polymers generally have densities of more than 2 g/cm³ and hence a high specific substance weight. For years, efforts have been made to develop halogen-free polymers having a water-vapour barrier action in order to avoid the environmental pollution which occurs during the combustion of halogen-containing polymers.

Films made of polypropylene are more advantageous from the environmental point of view and have good mechanical properties but, owing to the partially crystalline nature of this thermoplastic, these films have to be processed in narrow operating windows during thermoforming. Moreover, the water-vapour barrier action of these materials may be inadequate for many applications. As the outward appearance of the packaging and the visual presentation of the packaged goods can be of great importance, a high transparency is frequently also necessary. In this respect materials made of polypropylene have disadvantages.

The use of cycloolefin copolymers as film materials acting as water-vapour barriers is described in EP-A 570 188. Films made of these materials, owing to their amorphous character, can be thermoformed far more easily than can partially crystalline materials such as polypropylene. EP-A 920 989 mentions the instability of this class of materials in the presence of oils and fats and describes a multilayered film, the outer sides of which consist of polypropylene/polyethylene co-octene mixtures in order to protect the inner cycloolefin copolymer layer. For the processing of cycloolefin copolymers and in order to obtain visually perfect films, plasticisation with special screw-type machines is recommended (Plastics Special 6/1999). Here, certain compression zone distributions are to be maintained along a film extruder, in order thus to avoid a friction-induced appearance of specks in the film material. At higher compression, external lubricants are necessary. Polycycloolefins are produced from comparatively costly (co)monomers such as tetracyclododecene, ethylene tetracyclododecene, norbornene and others, a fact which has to be assessed as critical, in view of the above-mentioned cost pressure in connection with polymeric packaging materials having a barrier action.

Films made of polystyrene or polystyrene copolymers are known prior art. There are in existence innumerable materials having a wide range of properties. Because styrene-containing polymers have a varied range of applications (injection-moulded articles, polymeric foams, etc.) besides their use as film, the starting monomers used are very inexpensive. However, films made of styrene-containing polymers do not exhibit a particular barrier action against water vapour and are consequently unsuitable for the packaging of moisture-sensitive goods (H. Klein, Permeability of polystyrene film, Kunststoffe (1976), 66(3), 151-156). Instead of this, it is necessary to bond layers of other polymers having water-vapour barrier properties to the polystyrene layer (W. Schrenk et al., “Some physical properties of multilayered films”, Polym. Eng. Sci. (1996), 9(6), 393-396).

Surprisingly, it has now been found that this property is significantly altered and a material having a high water-vapour barrier action is formed as a result of the complete hydrogenation of polystyrene, which leads to polymers containing vinylcyclohexane. The unfavourably low toughness of polyvinylcyclohexane can be improved by incorporating soft segments. It has been found that this incorporation of soft segments, contrary to expectation, may even lead to an improvement in the water-vapour barrier action.

The present invention accordingly provides monofilms containing a vinylcyclohexane-based polymer or a mixture of vinylcyclohexane-based polymers with at least one polar polymer.

The thickness of the film may vary widely, according to use. It is generally 0.001 to 2 mm, preferably 0.005 to 1.5 mm, in particular 0.01 to 1 mm and most particularly preferably 0.01 to 0.7 mm. In the case of use as a flexible container, the thickness may even be up to 7 mm, preferably up to 5 mm.

The film according to the invention may also be provided with one or more layers, for example, a paper layer or metal layer.

By vinylcyclohexane-based polymers are meant homopolymers of vinylcyclohexane and copolymers or block copolymers of vinylcyclohexane and other copolymers.

A preferred homopolymer or copolymer is a vinylcyclohexane-based polymer having the repeating structural unit corresponding to formula (I),

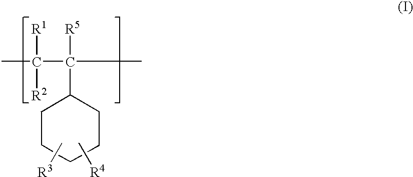

wherein

R¹ and R² independently of one another denote hydrogen or C₁-C₆-alkyl, preferably C₁-C₄-alkyl and

R³ and R⁴ independently of one another denote hydrogen or C₁-C₆-alkyl, preferably C₁-C₄-alkyl, in particular methyl and/or ethyl, or R³ and R⁴ together denote alkene, preferably C₃- or C₄-alkene (fused 5- or 6-membered cycloaliphatic ring),

R⁵ denotes hydrogen or C₁-C₆-alkyl, preferably C₁-C₄-alkyl,

R¹, R² and R⁵ independently of one another denote in particular hydrogen or methyl.

The following are preferably used as comonomers in the polymerisation of the starting polymer (optionally substituted polystyrene) and incorporated into the polymer: olefins having in general 2 to 10 C atoms, such as, for example and preferably, ethylene, propylene, isoprene, isobutylene, butadiene, particularly preferably isoprene and/or butadiene, C₁-C8-alkyl esters, preferably C₁-C₄-alkyl esters, of acrylic or methacrylic acid, unsaturated cycloaliphatic hydrocarbons, for example, cyclopentadiene, cyclohexene, cyclohexadiene, optionally substituted norbornene, dicyclopentadiene, dihydrocyclopentadiene, optionally substituted tetracyclododecenes, styrenes alkylated in the ring, α-methylstyrene, divinylbenzene, vinyl esters, vinyl acids, vinyl ethers, vinyl acetate, vinyl cyanides such as, for example, acrylonitrile, methacrylonitrile, maleic anhydride and mixtures of these monomers. The polymers can generally contain up to 60 wt. %, preferably up to 50 wt. %, particularly preferably up to 40 wt. % of comonomers (based on the polymer). Most particularly preferably, the polymers contain 1 to 30 wt. % of comonomers.

The vinylcyclohexane (co)polymers generally have absolute molecular weights M_{w} (weight average) of 1,000 to 10,000,000, preferably of 60,000 to 1,000,000, most particularly preferably 70,000 to 600,000, determined by light-scattering.

The vinylcyclohexane-based polymers can be either isotactic or syndiotactic. Particularly suitable polymers are the described vinylcyclohexane-based polymers in syndiotactic form, preferably having a syndiotactic diadene content of 50.1 to 74%, in particular of 52 to 70% (cf. WO 99/32528).

The polymers can have a linear chain structure or possess branch points via co-units (for example, graft copolymers). The centres of the branches comprise, for example, star-shaped or branched polymers. The polymers according to the invention may have other geometrical shapes: the primary, secondary, tertiary, optionally quaternary polymer structure. The helix, double helix, pleated sheet, etc., or mixtures of these structures may be mentioned here.

The copolymers used can be statistical or block-type polymers.

Block copolymers include diblocks, triblocks, multiblocks and star-shaped block copolymers.

The vinylcyclohexane-based (co)polymers are prepared by polymerising derivatives of styrene with the corresponding monomers, radically, anionically, cationically, or by metal-complex initiators or catalysts and then completely or partially hydrogenating the unsaturated aromatic bonds (cf. for example, WO 94/21694, EP-A 322, 731).

Preferably a block copolymer with at least three blocks which contains at least one hard block and at least one soft block is used, wherein the hard block contains at least 50 wt. %, preferably 60 wt. %, particularly preferably 65 wt. %, of repeating units corresponding to the general formula (II),

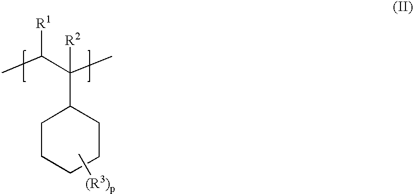

wherein

R¹ and R² independently of one another denote hydrogen or C₁-C₆-alkyl, preferably C₁-C₄-alkyl,

R³ denotes hydrogen or C₁-C₆-alkyl, preferably C₁-C₄-alkyl, in particular methyl and/or ethyl, or anellated alkene, preferably C₃-alkene or C₄-alkene (fused 5- or 6-membered cycloaliphatic ring),

p represents an integer 0, 1 to 5, preferably 0, 1 to 3,

and the soft block contains

100 to 50 wt. %, preferably 95 to 70 wt. %, of repeating units based on straight-chain or branched C₂-C₁₄-alkene, preferably C₂-C₈-alkene, and

0 to 50 wt. %, preferably 5 to 30 wt. %, of repeating units corresponding to the general formula (II).

The repeating units in the soft block can be distributed in a statistical, alternating or gradient manner.

The repeating units corresponding to formula (II) in the hard and soft block may be either identical or different. A hard block and a soft block may in their turn contain different repeating units corresponding to formula (II).

The hard blocks of the block copolymers usable according to the invention as polymer component A) may contain at most 35 wt. % of other repeating units, which are based on common, optionally substituted, olefinic copolymers, preferably cyclohexadiene substituted by C₁-C₄-alkyl, norbornene, dicyclopentadiene, dihydrocyclopentadiene, tetracyclododecene, vinyl esters, vinyl ethers, vinyl acetate, maleic acid derivatives and (meth)acrylic acid derivatives.

A suitable block copolymer may optionally contain further soft blocks consisting of repeating units based on saturated, optionally substituted by C₁-C₄-alkyl, aliphatic hydrocarbon chains having 2 to 10, preferably 2 to 5, carbon atoms and isomeric forms thereof.

The content of hard blocks (based on the total polymer) is generally 65 to 97 wt. %, preferably 75 to 95 wt. %, and the content of soft blocks is 3 to 35 wt. %, preferably 5 to 25 wt. %.

The usable block copolymer generally has molecular weights (number average) of 5,000 to 1,000,000, preferably of 50,000 to 500,000, particularly preferably 80,000 to 200,000, determined by gel permeation chromatography, calibrated with polystyrene standard. The molecular weight (number average) of the hard blocks is generally 650 to 970,000, preferably 6,500 to 480,000, particularly preferably 10,000 to 190,000. The molecular weight of the soft blocks is generally 150 to 350,000, preferably 1,500 to 170,000, particularly preferably 2,400 to 70,000. The block copolymer can contain hard blocks and soft blocks having different molecular weights.

The linking of the chain units can be a stereoregular head-to-tail linkage together with a small proportion of head-to-head linkage. The copolymers can be branched linearly or via centres. They may also have a star-shaped structure. In this invention, linear block copolymers are preferred.

The block copolymer can have various block structures, with the end blocks, independently of one another, being hard blocks or soft blocks. For example, they can be structured as follows:

A¹-(Bⁱ-Aⁱ)ₙ;

B¹-(Aⁱ-Bⁱ)ₙ;

(Aⁱ-Bⁱ)ₙ;

wherein

A denotes a hard block, B denotes a soft block,

n is ≧1, preferably 1, 2, 3, 4 and

i denotes an integer between 1 and n (1≦i≦n).

The hard and soft blocks in the block copolymer are generally incompatible with one another. This incompatibility results in the phase separation on the microscopic scale.

The production of the polymer component which can be used as component A) is preferably carried out, in a living polymerisation process, by reacting vinyl aromatic monomers corresponding to the general formula (III) for the hard blocks and conjugated dienes corresponding to the general formula (IV) and optionally vinyl aromatic monomers corresponding to the general formula (III) for the soft blocks

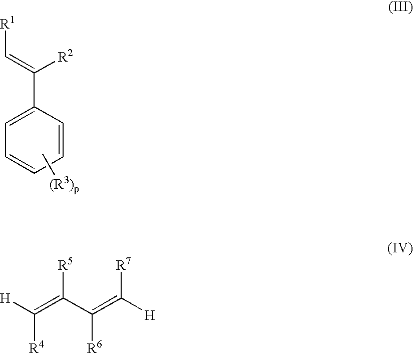

wherein

R¹, R², R3 and p have the meanings given above and

R⁴ to R⁷ independently of one another denote hydrogen, C₁-C₄-alkyl, preferably methyl,

to form a prepolymer and then the carbon-carbon double bonds of the prepolymer are hydrogenated in the presence of a homogeneous or heterogeneous catalyst.

The monomers corresponding to formula (III) can be identical or different in the hard block and soft block of the prepolymer. A hard block and a soft block may contain different repeating units based on monomers of formula (III).

The following are preferably used as comonomers in the polymerisation and incorporated into the hard blocks: cyclohexadiene, vinylcyclohexane, vinylcyclohexene, norbornene, dicyclopentadiene, dihydrocyclopentadiene, tetracyclododecene, styrenes alkylated in the ring, α-methylstyrene, divinylbenzene, vinyl esters, vinyl ethers, vinyl acetate, maleic acid derivatives and (meth)acrylic acid derivatives, etc., in each case optionally substituted by C₁-C₄-alkyl, or a mixture of these.

The prepolymer can be prepared by a living polymerisation process, such as, for example, a living anionic polymerisation or a living radical polymerisation. These methods of polymerisation are generally known in polymer chemistry. A living anionic polymerisation process, which can be initiated by alkali metals or by alkali metal alkyl compounds such as methyllithium and butyllithium, is particularly suitable. Suitable solvents for such a polymerisation are hydrocarbons such as, for example, cyclohexane, hexane, pentane, benzene, toluene, etc., and ethers such as, for example, diethyl ether, methyl tert. butyl ether, tetrahydrofuran.

Various block structures are attainable via a living polymerisation process. In the case of anionic polymerisation in a hydrocarbon medium such as cyclohexane or benzene, no chain termination and no chain transfer takes place where active pollutants such as water, oxygen, carbon dioxide, etc., are excluded. Block copolymers having specific block segments can be produced by sequential additions of monomer or monomer mixture. Thus, for example, a styrene-isoprene or styrene-butadiene diblock copolymer can be produced by adding the styrene monomer after complete polymerisation of diene. In the present invention, the chain structure is represented by the symbol (I)ₘ-(S)ₙ or (B)ₘ-(S)ₙ or, in simplified form, by IS or BS. m, n denote the degree of polymerisation in the respective blocks.

It is also known that block copolymers containing a mixed block (“smudged” block boundary) can be produced by utilising the favourable cross-polymerisation conditions and starting the polymerisation in a monomer mixture. Thus, for example, styrene-butadiene diblock copolymer containing a diene-rich mixed block as the soft block can be produced by initiation in a mixture of styrene and butadiene in a hydrocarbon medium. The polymer chain contains a diene-rich soft block, a transition stage with increasing degrees of incorporation of styrene and a styrene block, which terminates the chain. The chain structure is denoted by the symbol (I^{I/S})ₘ-(S)ₙ or (B^{B/S})ₘ-(S)ₙ or, in simplified form, by I^{IS}S or B^{BS}S, with I^{IS} and B^{BS} denoting the isoprene-rich and butadiene-rich soft block respectively. The corresponding hydrogenated products are represented as H-I^{IS}S and H-B^{BS}S respectively.

Multiblock copolymers containing both mixed and specific soft blocks can be produced by a combination of the two above-mentioned procedures. Examples are triblock SI^{IS}S, I^{IS}SI and pentablock S(I^{IS}S)₂, (I^{IS}S)₂I. The symbols are self-explanatory. The corresponding hydrogenated products are represented as H-SI^{IS}S, H-I^{IS}SI and H-S(I^{IS}S)₂, H-(I^{IS}S)₂I respectively.

In anionic polymerisation, it is possible to control the molecular weight by varying the monomer/initiator ratio. The theoretical molecular weight can be calculated from the following equation:

$$M = \frac{\text{Total weight of the monomers} ( g )}{\text{Quantity of initiator} ( mol )}$$

Other factors, such as solvent, cosolvent, cocatalyst, can also sensitively influence the chain structure. Hydrocarbons such as, for example, cyclohexane, toluene or benzene are preferred solvents for the polymerisation in the present invention, because in these solvents block copolymers containing a mixed block can be obtained and the diene monomer preferably polymerised to form the highly elastic 1,4-polydiene. A cosolvent containing oxygen and nitrogen, such as, for example, tetrahydrofuran, dimethoxyethane or N,N,N′,N′-tetramethylthylenediamine brings about a statistical polymerisation and at the same time a preferable 1,2-polymerisation of conjugated dienes. In contrast to this, alkali metal alkoxides such as, for example, lithium tert-butoxide, bring about a statistical polymerisation but have little influence on the 1,2-/1,4 ratio of diene polymerisation. The microstructure of the soft blocks in the prepolymer is a decisive factor in determining the microstructure of the soft blocks in the corresponding hydrogenated block copolymer. Thus, for example, a poly-1,4-butadiene block on hydrogenation results in a polyethylene segment, which can crystallise. The hydrogenation product of poly-1,2-butadiene has an excessively high glass transition temperature and is consequently inelastic. The hydrogenation of a polybutadiene block having suitable 1,2/1,4 ratios can provide an elastic poly(ethylene-co-butylene) segment. Where isoprene is the comonomer for the soft block, 1,4-polymerisation is preferred, as an alternating poly(ethylene-propylene) elastomer block is obtained after hydrogenation.

Temperature, pressure and monomer concentration are largely unimportant in the polymerisation. A preferred temperature, pressure and monomer concentration for the polymerisation is within the range of −60° C. to 130° C., particularly preferably 20° C. to 100° C.; 0.8 to 6 bar and 5 to 30 wt. % (based on the sum of the quantities of monomer and of solvent).

The process for producing the block copolymers is carried out alternatively with or without, but preferably without, working-up between polymerisation step and hydrogenation step in order to isolate the prepolymer. A possible working-up can be carried out by known methods, such as precipitation in a nonsolvent such as, for example, C₁-C₄-alcohol and C₃-C₆-ketone, devolatilising extrusion or stripping, etc. In this case the prepolymer is redissolved in a solvent for the hydrogenation. Without working-up, the prepolymer solution can be hydrogenated directly—optionally after chain termination and optionally diluted with the same inert solvent as in the polymerisation or with another inert solvent. In this case, a saturated hydrocarbon such as, for example, cyclohexane, hexane or mixtures thereof is particularly preferred as the solvent for the process.

The vinylcyclohexane-based copolymers or homopolymers are produced by polymerising derivatives of styrene with the corresponding monomers radically, anionically, cationically, or by metal-complex initiators or catalysts and then completely or partially hydrogenating the unsaturated aromatic bonds (cf. for example, WO 94/21694, EP-A 322 731).

The hydrogenation of the prepolymers is carried out by generally known methods (for example, WO 94/02720, WO 96/34895, EP-A 322 371). WO 94/21694 describes a process for the complete hydrogenation of alkenyl-aromatic polymers and poly(alkenyl-aromatic)/polydiene block copolymers by heterogeneous catalysis.

A multitude of known hydrogenation catalysts can be used as catalyst. Preferred metal catalysts are mentioned, for example, in WO 94/21694 or WO 96/34896. Any known catalyst for hydrogenation reactions can be used as catalyst. Catalysts having a large surface area (for example, 100 to 600 m²/g) and a small average pore diameter (for example, 20-500 Å) are suitable. Suitable catalysts are also those having a small surface area (for example, >10 m²/g) and large average pore diameters, which are characterised in that 98% of the pore volume contains pores having pore diameters of more than 600 Å (for example, approx. 1,000 to 4,000 Å) (cf. e.g. U.S. Pat. Nos. 5,654,253, 5,612,422, JP-A 03076706). In particular, Raney nickel, nickel on silicon dioxide or silicon dioxide/aluminium oxide, nickel on carbon as support and/or precious metal catalysts, for example, Pt, Ru, Rh, Pd, are used.

The polymer concentrations, based on the total weight of solvent and polymer, are generally 80 to 1 wt. %, preferably 50 to 10, in particular 40 to 15 wt. %.

The hydrogenation is generally carried out at temperatures of between 0° C. and 500° C., preferably between 20° C. and 250° C., in particular between 60° C. and 200° C.

The solvents which can conventionally be used for hydrogenation reactions are described, for example, in DE-AS 1 131 885.

The reaction is generally carried out at pressures of 1 bar to 1000 bar, preferably 20 to 300 bar, in particular 40 to 200 bar.

The process generally leads to a virtually complete hydrogenation of the aromatic units and optionally of double bonds in the main chain. As a rule the degree of hydrogenation is more than 97%, particularly preferably more than 99%. The degree of hydrogenation can be determined, for example, by NMR or UV spectroscopy.

The quantity of catalyst used depends on the procedure. The process can be carried out continuously, semi-continuously or batchwise.

The ratio of catalyst to prepolymer, for example, in the batchwise process, is generally 0.3 to 0.001, preferably 0.2 to 0.005, particularly preferably 0.15 to 0.01.

The invention also relates to a process for producing the film according to the invention by the known per se extrusion process. The procedure there is that the polymer is fed to a screw conveyor via a metering device, heated and melted and extruded in the form of melt through a sheet die. The film of melt is drawn over a system of rolls and the film optionally oriented, in succession or at the same time, longitudinally and/or transversely with or without tempering (longitudinally, by means of high-speed rolls; transversely, for example, with the aid of a clamping frame), thermofixed, corona- or flame-treated and finally wound up. It has been found advantageous to temper the haul-off roll or rolls corresponding to the glass transition temperature of the polymer.

The film can also be stretched.

The layer containing the polyvinylcyclohexane-based polymer may also contain a further polar polymer in addition to the vinylcyclohexane-based polymer. Because of the lesser transparency of single-layer films based on mixtures of polyvinylcyclohexane-based polymers with polar polymers, these are suitable only for those applications in which the transparency is not a necessary criterion. For the purpose of the present invention, polar polymers are selected preferably from among polycarbonate, polyamide, polyester and polyurethane or mixtures of these, particularly preferably polycarbonate and/or polyamide.

The layer contains preferably up to 8 wt. % of a polar polymer or a mixture of these, based on the total quantity of polymer in this layer and particularly preferably 0.1 to 6 wt. %, in particular 0.5 to 5 wt. %, of a polar polymer or a mixture of these. Most particularly preferably the layer contains up to 3 wt. % of polar monomer.

Suitable polyamides are known homopolyamides, copolyamides and mixtures of these polyamides. These can be partially crystalline and/or amorphous polyamides.

Suitable partially crystalline polyamides are polyamide 6, polyamide 6,6, mixtures and corresponding copolymers of these components. Suitable partially crystalline polyamides are also those whose acid component is wholly or partially selected from at least one acid from among terephthalic acid, isophthalic acid, suberic acid, sebacic acid, azelaic acid, adipic acid, cyclohexanedicarboxylic acid and whose diamine component is wholly or partially selected from m- and/or p-xylylenediamine, hexamethylenediamine, 2,2,4-trimethylhexamethylenediamine, 2,4,4-trimethylhexamethylenediamine and isophoronediamine and whose composition is in principle known.

Mention may also be made of polyamides which are prepared completely or partially from lactams containing 7 to 12 C atoms in the ring, optionally with concomitant use of one or more of the above-mentioned starting components.

Polyamide 6 and polyamide 6,6 and mixtures thereof are particularly preferred partially crystalline polyamides. Known products can be used as the amorphous polyamides. They are obtained by polycondensation of diamines, selected preferably from ethylenediamine, hexamethylenediamine, decamethylenediamine, 2,2,4- and/or 2,4,4-trimethylhexamethylenediamine, m- and/or p-xylylenediamine, bis(4-aminocyclohexyl)methane, bis(4-aminohexyl)propane, 3,3′-dimethyl-4,4′-diaminodicyclohexylmethane, 3-aminomethyl-3,3,5-trimethylcyclohexylamine, 2,5- and/or 2,6-bis(aminomethyl)norbornane and/or 1,4-diaminomethylcyclohexane or mixtures of these with dicarboxylic acids, selected preferably from oxalic acid, adipic acid, azelaic acid, decanedicarboxylic acid, heptadecanedicarboxylic acid, 2,2,4- and/or 2,4,4-trimethyladipic acid, isophthalic acid and terephthalic acid or mixtures of these.

Copolymers obtained by polycondensation of several monomers are also suitable, as are copolymers produced with the addition of aminocarboxylic acids such as aminocaproic acid, aminoundecanoic acid or aminolauric acid or lactams thereof.

Particularly preferred amorphous polyamides are the polyamides prepared from isophthalic acid, hexamethylenediamine and other diamines such as 4,4′-diaminodicyclohexylmethane, isophoronediamine, 2,2,4- and/or 2,4,4-trimethylhexamethylenediamine, 2,5- and/or 2,6-bis(aminomethyl)norbornene; or from isophthalic acid, 4,4′-diaminodicyclohexylmethane and caprolactam; or from isophthalic acid, 3,3′-dimethyl-4,4′-diaminodicyclohexylmethane and lauryl lactam; or from terephthalic acid and from the isomeric mixture of 2,2,4- and/or 2,4,4-trimethylhexamethylenediamine.

Instead of the pure 4,4′-diaminodicyclohexylmethane, it is also possible to use mixtures of the positional isomeric diaminodicyclohexylmethanes, which consist of

| | |
|---|---|
| 70 to 99 mol. % | of the 4,4″-diamino isomer |
| 1 to 30 mol. % | of the 2,4″-diamino isomer |
| 0 to 2 mol. % | of the 2,2″-diamino isomer |

optionally corresponding to more highly condensed diamines, which are obtained by hydrogenation of diaminodiphenylmethane of technical grade. Isophthalic acid can be replaced to the extent of up to 30% by terephthalic acid.

Polyamide 6, polyamide 6,6, polyamide 8, polyamide 10, polyamide 11 and polyamide 12 are preferred. Polyamide 6 and polyamide 6,6 are particularly preferred.

The polyamides have a relative viscosity (measured on a 1 wt. % solution in m-cresol at 25° C.) preferably of 2 to 5, particularly preferably of 2.5 to 4.

Preferred polyalkylene terephthalates can be prepared by known methods from terephthalic acid (or its reactive derivatives) and aliphatic or cycloaliphatic diols having 2 to 10 C atoms (Kunststoff-Handbuch, Vol. VIII, p. 695 ff, Karl-Hanser Verlag, Munich 1973).

Preferred polyalkylene terephthalates contain at least 80, preferably 90 mol. %, based on the dicarboxylic acid component, of terephthalate groups and at least 80, preferably at least 90 mol. %, based on the diol component, of diols selected from the group comprising ethylene glycol, propylene glycol, 1,4-butanediol, cyclohexane-1,4-dimethanol or mixtures of these.

In addition to terephthalic esters, the preferred polyalkylene terephthalates may also contain up to 20 mol. %, preferably up to 10 mol. %, of other aromatic dicarboxylic acids having 8 to 14 C atoms or of aliphatic dicarboxylic acids having 4 to 12 C atoms, such as groups from phthalic acid, isophthalic acid, 2,6-naphthalene-dicarboxylic acid, 4,4′-diphenyldicarboxylic acid, succinic acid, adipic acid, sebacic acid, azelaic acid, cyclohexanediacetic acid.

In addition to the above-mentioned diols, the preferred polyalkylene terephthalates may also contain up to 20 mol. %, preferably up to 10 mol. %, of other aliphatic diols having 3 to 12 C atoms or cycloaliphatic diols having 6 to 21 C atoms, for example and preferably groups from 1,3-propanediol, 2-ethyl-1,3-propanediol, neopentyl glycol, 1,5-pentanediol, 1,6-hexanediol, 3-methyl-2,4-pentanediol, 2-methyl-2,4-pentanediol, 2,2,4-trimethyl-1,3-pentanediol and 1,6,2-ethyl-1,3-hexanediol, 2,2-diethyl-1,3-propanediol, 2,5-hexanediol, 1,4-di(β-hydroxyethoxy)benzene, 2,2-bis(4-hydroxycyclohexyl)propane, 2,4-dihydroxy-1,1,3,3,-tetra-methylcyclobutane, 2,2-bis(3-β-hydroxyethoxyphenyl)propane and 2,2-bis(4-hydroxy-propoxyphenyl)propane (DE-A 24 07 674, 24 07 776 and 27 15 932).

The polyalkylene terephthalates can be branched by the incorporation of relatively small quantities of trihydric or tetrahydric alcohols or tribasic or tetrabasic carboxylic acids of the type described, for example, in DE-A 19 00 270 and in U.S. Pat. No. 3,692,744. Examples of preferred branching agents are trimesic acid, trimellitic acid, trimethylolethane, trimethylolpropane and pentaerythritol.

It is advisable to use not more than 1 mol. % of the branching agent, based on the acid component.

Polyalkylene terephthalates which are synthesised solely from terephthalic acid and ethylene glycol, propylene glycol or 1,4-butanediol or copolymers thereof with 1,4-dicyclohexanedimethanol, as well as mixtures of these polyalkylene terephthalates, are particularly preferred.

The polyalkylene terephthalates generally have an intrinsic viscosity of approximately 0.4 to 1.5 dl/g, preferably 0.5 to 1.3 dl/g, in each case measured in phenol/o-dichlorobenzene (1:1 parts by weight) at 25° C.

Polyesters are described, for example, in EP-A 774,490.

Polyolefins for the purpose of the invention are polyethylene, polypropylene, poly-1-butene and polymethylpentene, which may contain small quantities of non-conjugated dienes incorporated by polymerisation. Polyolefins are known and are described in Römpps Chemielexikon and in the literature cited therein. Polypropylene is preferred.

Polycarbonates for the purpose of the invention are those of the type described, for example, in EP-A 640 655.

Preferred aromatic polycarbonates are polycarbonates based on 2,2-bis(4-hydroxyphenyl)propane or on one of the other diphenols mentioned in EP-A 640 655 as being preferred. Most particularly preferred are those based on 2,2-bis(4-hydroxy-phenyl)propane, 2,2-bis(3,5-dimethyl-4-hydroxyphenyl)propane or 1,1-bis(4-hydroxyphenyl)-3,3,5-trimethylcyclohexane or mixtures of 2,2-bis(4-hydroxy-phenyl)propane and 1,1-bis(4-hydroxyphenyl)-3,3,5-trimethylcyclohexane.

Polycarbonates based on bisphenol A are most particularly preferred.

The aromatic polycarbonates generally have average molecular weights M_{w} of approximately 10,000 to 200,000, preferably 20,000 to 80,000 (determined by gel chromatography after previous calibration).

Additives

Additives may be incorporated into the film according to the invention. These are added, prior to or during processing, to the polymer or to the mixture of polymers used for the production of the film. The object of such an addition is to facilitate processing or to improve the properties of the end product. Important types of additives are antiblocking agents, heat stabilisers or oxidation stabilisers, antistatic agents, biostabilisers, colouring agents, lubricants, light-protecting agents, optical brighteners, additives for improving the printability, etc.

Suitable antiblocking agents are inorganic additives such as silicon dioxide, calcium carbonate, magnesium silicate, aluminium silicate, calcium phosphate and the like and/or incompatible organic polymers such as polyamides, polyesters, polyurethanes, polycarbonates, etc.. The effective quantity of antiblocking agent is within the range of 0.1 to 2 wt. %, preferably 0.1 to 0.5 wt. %. The average particle size is between 1 and 6 μm, in particular 2 and 5 μm, particles having a spherical shape being particularly suitable.

All the common heat stabilisers can be used as stabilisers. In general, sterically hindered phenols, phosphorus compounds and lactone derivatives can be used either on their own or as binary or ternary mixtures. Ternary mixtures are particularly preferred, in particular mixtures of Irganox 1010 (phenol component), Irgafos P-EPQ (phosphorus compound) and HP 136 (lactone derivative) from the firm of CIBA Speciality Chemicals, Basel, Switzerland.

Preferred antistatic agents are alkali-alkane sulfonates, polyether-modified, i.e. ethoxylated and/or propoxylated polydiorganosiloxanes (polydialkylsiloxanes, polyalkylphenylsiloxanes, etc.) and/or the substantially straight-chain and saturated aliphatic, tertiary amines containing an aliphatic group having 10 to 20 carbon atoms, which are substituted with ω-hydroxy-(C₁-C₄)-alkyl groups, with N,N-bis(2-hydroxyethyl)alkylamines having 10 to 20 carbon atoms, preferably 12 to 18 carbon atoms, in the alkyl group being particularly suitable. The effective quantity of antistatic agent is within the range of 0.05 to 0.3 wt. %.

Suitable colouring agents are dyes and pigments, which can be of inorganic or organic nature. Examples are titanium dioxide, carbon black, oxides and/or mixed oxides of chromium, nickel, iron, azo pigments and phthalocyanines.

Lubricants are hydrocarbons, such as paraffin oils, waxes (for example, polyethylene waxes and polypropylene waxes), higher alcohols and carboxylic acids, carboxylic esters and carboxylic acid amides, glycerides, higher aliphatic acid amides, higher aliphatic esters and polydimethylsiloxanes. The effective quantity of lubricant is within the range of 0.01 to 4 wt. %, particularly preferably 0.25 to 1 wt. %.

Light-protecting agents are additives which protect films from the action of light. Various classes are distinguished, depending on the mechanism of action. In the case of films, mostly hydroperoxide decomposers (metal complexes, sulfur-containing organic compounds), quenchers (for example, nickel complexes of sulfide group-containing phenols), free-radical scavengers (for example, sterically hindered amines) and rare UV absorbers (for example, hydroxybenzophenones, hydroxyphenylbenzotriazoles) are used. The effective quantity of light-protecting agent is between 0.01 and 3 wt. %, particularly preferably 0.5 and 2 wt. %.

Optical brighteners are additives which compensate for the yellowish appearance of many plastics films, which is caused by an absorption of blue wavelength ranges (blue effect). Examples are triazine-phenylcoumarins, benzotriazole-phenylcoumarins and benzoxazoles. The effective quantity is between 0.001 and 0.1 wt. %, particularly preferably 0.01 and 0.05 wt. %.

Low-molecular resins can be added for further improvement of the required physical properties (for example, rigidity of the films, shrinkage behaviour, appearance, water-vapour transmission). Compatible hydrocarbon resins are low-molecular polymers having a molecular weight M_{w} generally within a range of 300 to 8,000, preferably 400 to 5,000, particularly preferably 500 to 2,000. The resin content is within a range of 1 to 30 wt. %, preferably 2 to 30 wt. %. Hydrocarbon resins are preferred.

The printability of the film can be improved, without significant loss of the water-vapour barrier action, by increasing the polarity of the surface in a suitable manner. This can be effected by means of a corona treatment or by introducing organic or inorganic additives. Suitable organic additives are polymers such as polypropylene or polyethylene in the form of homopolymers or copolymers, polyesters, polyamides, polycarbonate, polyacetals, polyurethanes, acrylic or methacrylic polymers or mixtures of these. The layer contains preferably 0.05 to 8 wt. %. Suitable inorganic pigments are titanium dioxide, barium sulfate, calcium sulfate or calcium carbonate.

Sealing layers can be applied to the films according to the invention in order to improve their adhesion to films or containers made of thermoplastic polymers. The sealing layers must be suited to the application. Materials which can be used as sealing layers are, for example, ethylene polymers and propylene polymers containing different proportions of polar groups, which are obtainable by co-polymerisation, for example, with vinyl acetate, or with acrylic monomers, or polymers based on copolymers of ethylene or propylene with alpha-olefins and polar monomers. Grafted (for example, maleic anhydride) ethylene copolymers and propylene copolymers can also be used as sealing layers. The sealing temperatures can be adjusted through selection of the appropriate composition.

The films according to the invention can be used in a variety of ways, for example, as packaging for foods, blister packaging, packaging of electronic articles and as electrical capacitor films.

The invention is illustrated with the aid of the following Examples:

### EXAMPLES

### Example 1

Unoriented Film Made of PVCH Homopolymer

Synthesis of Polymer

An autoclave was flushed with inert gas (nitrogen). The polymer solution used was filtered through an SBF-101-S16 filter (Loeffler, Filter-Technik, Nettersheim, Germany) and placed in the autoclave, together with the catalyst (Table 1). The autoclave was closed and then impinged on several times with protective gas, then with hydrogen. After release, the specific hydrogen pressure was established and the autoclave was heated to the appropriate reaction temperature, with stirring. The reaction pressure was maintained constant after commencement of the hydrogen uptake. The reaction time is defined as being from the heating of the batch up to the time when the hydrogen uptake is approaching its saturation value.

On completion of hydrogenation, the polymer solution was filtered through a pressure filter covered with a Teflon cloth (B43-MU10, Dr. M, Männendorf, Switzerland). The product solution was then filtered through a 0.2 μm Teflon filter (Pall Filtertechnik, Dreieich, Germany). The polymer solution was stabilised with Irganox XP 420 FF (CIBA Speciality Chemicals, Basel, Switzerland) and again filtered using the above-mentioned 0.2 μm filter. Subsequently the polymer solution was freed from solvent at 240° C., the melt was filtered through a 20 μm filter and the product was granulated. Neither aromatic nor olefinic carbon-carbon double bonds was detectable by ¹H-NMR spectroscopy.

TABLE 1
Hydrogenation of polystyrene

| | | | | | | | Degree of |
|---|---|---|---|---|---|---|---|
| | Polymer | | Catalyst | Reaction | Hydrogen | Reaction | hydro- |
| Ex. | weight¹ | Solvent | weight² | temp. | pressure | time | genation³ |
| No. | [kg] | [L] | [g] | [° C.] | [bar] | [h] | [%] |
| 1 | 4.8 | 15.1 | 625 | 160 | 100 | 19 | 100 |
| | | cyclohexane | | | | | |
| | | 10.1 | | | | | |
| | | methyl-t- | | | | | |
| | | butyl ether | | | | | |

¹Polystyrene, type 158 k, glass-clear, M_{w} = 280,000 g/mol, BASF AG, Ludwigshafen, Germany
²Ni/SiO₂/Al₂O₃, Ni-5136 P, Engelhard, Dc Meern, Netherlands
³Determined by ¹H-NMR spectroscopy

Production of Film

This PVCH homopolymer, having a weight average molecular weight M_{w}=161,200, a density ρ=0.947 g·cm⁻³, a glass transition temperature T_{g}=148° C. and a melt flow index MFR=5.46 g/10 min., was extruded, at a material temperature (nozzle) of 310° C., by means of a Göttfert single-screw extruder (30 mm screw diameter, length of screw 25 D) through a sheet die (220 mm slit length, gap width controllable between 0.01-0.6 mm). The temperature of the casting roll was 90° C. A 50 μm thick, clear transparent film was obtained, which was wound up with a take-up speed of 11 m/min.

### Example 2

Oriented PVCH Homopolymer Film

The PVC homopolymer from Example 1 was extruded, at a material temperature of 310° C., by means of a single-screw extruder (screw diameter 60 mm, length of screw 25 D) through a sheet die (450 mm slit length, gap width 0.8 mm). The temperature of the casting roll was 90° C. An approximately 600 μm thick, clear transparent film was obtained, which was subsequently oriented at a stretching temperature of 250° C. (120 s preheating time) and at a specific stretching ratio of 1:2 in the longitudinal and in the transverse direction relative to the take-up direction.

### Example 3

Unoriented PVCH Copolymer Film (5 wt. % Ethylene-propylene Content)

Synthesis of Polymer

26 kg dry cyclohexane and 2.138 kg dry styrene were placed, with the exclusion of air and water (argon atmosphere), in a thermostatically controlled 50 l agitated tank, equipped with agitator and thermosensor. The contents of the autoclave were rendered inert by repeated exposure to nitrogen. Following heating to 70° C., 22.5 ml (36 mmol) n-butyllithium (1.6 M solution in hexane) was introduced by injection. The internal temperature was raised to 70° C. and stirring was continued for one hour. Then a mixture of 225 g dry isoprene and 2.138 g dry styrene was added and stirring was continued for three hours. After the reaction mixture had been cooled to room temperature, the viscous solution was arrested with isopropanol. The determination of the solids content indicated that the conversion was quantitative. The hydrogenation was carried out as described in Example 1.

Production of Film

This triblock copolymer, built up from PVCH and alternating ethylene-propylene (E/P) middle block soft segments, having a PVCH gradient (E/P content=5 wt. %), a weight average molecular weight M_{w}=121,800, a density ρ=0.947 g·cm⁻³, a glass transition temperature (hard block) T_{g}=148° C., was processed at 280° C. to form a pressed film having an average film thickness of 118 μm.

### Example 4

### Unoriented Film Made of PVCH Triblock Copolymer (15 wt. % Ethylene-propylene Content)

Synthesis of Polymer

The polymer was prepared from 153 g styrene and 27 g isoprene, as described in Example 3.

Production of Film

The triblock copolymer, built up from PVCH and alternating ethylene-propylene middle block soft segments, having a PVCH gradient (E/P content=15 wt. %), a weight average molecular weight M_{w}=114,700 and a glass transition temperature (hard block) T_{g}=148° C., was extruded, at a material temperature (nozzle) of 290° C., by means of a single-screw extruder (37 mm screw diameter, length of screw 24 D) through a sheet die (300 mm slit length, gap width 0.8 mm). The temperature of the casting roll was 120° C. A 50 μm thick, clear transparent film was obtained, which was wound up with a take-up speed of 6 m/min.

### Comparison Example 1

Unoriented Polystyrene Film

Polystyrene 158K (BASF, Ludwigshafen, Germany), having a weight average molecular weight M_{w}=260,400, a density ρ=1.05 g·cm⁻³, a glass transition temperature T_{g}=100° C. and a melt flow index MFR=27.4 g/10 min., was extruded, at a material temperature (nozzle) of 250° C., by means of a Göttfert single-screw extruder (30 mm screw diameter, length of screw 25 D) through a sheet die (220 mm slit length, gap width adjustable between 0.01-0.6 mm). The temperature of the casting roll was 90° C. A 50 μm thick, clear transparent film was obtained, which was wound up with a take-up speed of 7.3 m/min.

### Comparison Example 2

Oriented Polystyrene Film

The same type of polystyrene as in Comparison Example 1 was extruded, at a material temperature (nozzle) of 250° C., by means of a single-screw extruder (screw diameter 60 mm, length of screw 25 D) through a sheet die (450 mm slit length, gap width 0.8 mm). The temperature of the casting roll was 90° C. An approximately 600 μm thick, clear transparent film was obtained, which was subsequently oriented at a stretching temperature of 180° C. (90 s preheating time) and at a specific stretching ratio of 1:2 in the longitudinal and in the transverse direction relative to the take-up direction.

The following methods of measurement were used for the characterisation of the raw materials and films:

Melt flow index MFR

The melt flow index was determined in accordance with DIN ISO 1133 at 280° C. under a weight of 2.16 kg using a Meltflixer LT (SWO Polymertechnik GmbH).

Molecular weight M_{w}

The weight average molecular weight M_{w}, which is given in the description of the Examples, gives the weight average of the molecular weight. A two-detector gel permeation chromatography (0.5 wt. % solution, solvent tetrahydrofuran, 25° C., polystyrene standard) was used for its determination. The detection was carried out by means of UV absorption spectroscopy at 254 nm and by means of differential refractometry of the fractions. The calibration was carried out using several polystyrene standards of known molecular weight.

Glass transition temperature T_{g}

Injection-moulded standard specimens (flat rods 80×10×4 mm) of the samples were investigated by means of DMA (Dynamic Mechanical Analysis). Here the complex shear modulus in relation to the temperature was determined at a measuring frequency of 1 Hz. Measuring device: RDA-II from Rheometric Scientific, Inc., Piscataw, N.J. USA.

Elongation behaviour of the plastics films under stress

The test was carried out, in accordance with DIN EN ISO 527, on sample strips of 15 mm in width. The modulus of elasticity of elongation was found from the quotient of the difference in stress at 0.05 and 0.25% elongation relative to the cross-section of the clamp. The tensile strength is the maximum stress which the sample bears during the tensile test. The breaking elongation is the elongation of the sample at breakage.

Water-vapour transmission WVT

The water-vapour transmission WVT of the samples was determined by two different methods, depending on the water-vapour transmission. For samples of film having a water-vapour transmission>1 g·d⁻¹·m⁻², the determination was conducted by the gravimetric method in accordance with DIN 53 122, Part 1; in the case of water-vapour transmissions<1 g·d⁻¹·m⁻², the determination was conducted by the electrolysis method in accordance with DIN 53 122, Part 2.

Measurement of gloss

According to DIN 67 530, the regularly reflected portion of light, relative to an incident ray of light at less than 20° to the perpendicular is referred to as gloss. The gloss is given in gloss units GU, which are referred to a black glass standard.

Haze

The haze was measured in accordance with ASTM D 1003-61, Procedure A. It is the percentage of light which leaves the sample after transillumination with a central ray with a solid angle of >8° up to a maximum of 160°. It is related to the total quantity of transilluminating light, which equals 100%.

Table 2 contains the water-vapour transmissions measured for Examples 1 to 4, as well as optical and mechanical measured data. It can be seen that polyvinylcyclohexane-based monofilms have a specific water-vapour barrier action which exceeds that of polystyrene films by at least a power of ten. From Example 3, it is clear that the incorporation of a comonomer results in a further improvement of the water-vapour barrier action. The films are highly transparent, as is evidenced by the low degrees of haze. Water-vapour barrier films based on vinylcyclohexane-containing polymers extend the technically available range of commercial water-vapour barrier films by providing highly transparent polyolefin films based on inexpensive raw materials.

TABLE 2

| | | | Modulus of | Tensile | Breaking | | | | |
|---|---|---|---|---|---|---|---|---|---|
| | | | elasticity | strength | elongation | | | | |
| | | Thickness | longitudinal | longitudinal | longitudinal | WVT | WVT | | |
| | | of film | transverse | transverse | transverse | 38° C./90% r.h. | 23° C./85% r.h. | Haze | Gloss |
| Ex. | | [μm] | [MPa] | [MPa] | [%] | [g · mm · d⁻¹ · m⁻² | [g · mm · d⁻¹ · m⁻² | [%] | [GU] |
| 1 | PVCH | 52.3 | 2571 | 35.2 | 1.7 | 0.332 | 0.198 | 0.2 | 180 |
| | homopolymer | | 2547 | 26.8 | 1.3 | | | | |
| | unstretched | | | | | | | | |
| 2 | PVCH | 75.8 | 2542 | 16.2 | 0.8 | — | 0.110 | — | — |
| | homopolymer | | 2405 | 16.7 | 0.9 | | | | |
| | stretched | | | | | | | | |
| 3 | PVCH copolymer | 118 | — | — | — | 0.106 | — | — | — |
| | 5% comonomer | | | | | | | | |
| 4 | PVCH copolymer | 52.8 | 1760 | 45.7 | 4.2 | 0.260 | — | 0.2 | 152 |
| | 15% comonomer | | 1836 | 32.6 | 2.1 | | | | |
| C1 | PS, unstretched | 56.9 | 2737 | 47.9 | 3.8 | 3.122 | 1.463 | 0.2 | 182 |
| | | | 2960 | 37.4 | 1.5 | | | | |
| C2 | PS, stretched | 128.3 | 2649 | 42.4 | 2 | — | 1.604 | — | — |
| | | | 2529 | 44.9 | 2.5 | | | | |

1. Monofilms containing a vinylcyclohexane-based polymer or a mixture of vinylcyclohexane-based polymers with at least one polar polymer.

2. Monofilm according to claim 1, having a thickness of up to 7 mm.

3. Monofilm according to claim 1 or 2, having a thickness of from 0.001 to 2 mm.

4. Monofilm according to one or more of the preceding claims, wherein the vinylcyclohexane-based polymer is a homopolymer, copolymer or block copolymer.

5. Monofilm according to one or more of the preceding claims, containing a vinylcyclohexane-based polymer having the repeating structural unit corresponding to formula (I), 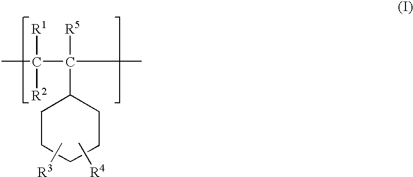
wherein
R¹ and R² independently of one another denote hydrogen or C₁-C₆-alkyl and
R³ and R⁴ independently of one another denote hydrogen or C₁-C₆-alkyl, or R³ and R⁴ together denote alkene,
R⁵ denotes hydrogen or C₁-C₆-alkyl and
wherein comonomers selected from among olefins, C₁-C₈-alkyl esters of acrylic or methacrylic acid, unsaturated cycloaliphatic hydrocarbons, substituted tetracyclododecenes, styrenes alkylated in the ring, α-methylstyrene, divinylbenzene, vinyl esters, vinyl acids, vinyl ethers, vinyl acetate, vinyl cyanides, maleic anhydride and mixtures of these monomers are added to the polymerisation and can be incorporated by polymerisation.

6. Monofilm according to one or more of the preceding claims, containing a block copolymer with at least three blocks, which contains at least one hard block and at least one soft block, wherein the hard block contains at least 50 wt. % of repeating units corresponding to the general formula (II), 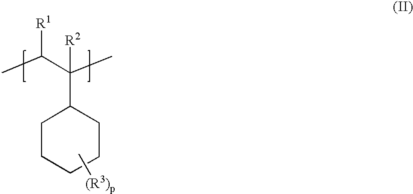
wherein
R¹ and R² independently of one another denote hydrogen or C₁-C₆-alkyl,
R³ denotes hydrogen or C₁-C₆-alkyl or annelated alkene,
p represents an integer 0, 1 to 5
and the soft block contains
100 to 50 wt. % of repeating units based on straight-chain or branched C₂-C₁₄-alkene and
0 to 50 wt. % of repeating units corresponding to the general formula (II).

7. Monofilm according to one or more of the preceding claims, containing at least one other polymer selected from among polyamides, polycarbonates, polyolefins, polyurethanes and polyesters.

8. Monofilm according to one or more of the preceding claims, containing up to 8 wt. % of a further polar polymer or a mixture thereof.

9. Monofilm according to one or more of the preceding claims, wherein the layer in addition contains conventional additives.

10. Monofilm according to claim 9, containing at least one additive selected from among antiblocking agents, heat stabilisers or oxidation stabilisers, antistatic agents, biostabilisers, colouring agents, lubricants, light-protecting agents, optical brighteners, additives for improving the printability.

11. Use of the monofilms according to one or more of the preceding claims for blister packaging, packaging of electronic articles or foods and as electrical capacitor films.

12. Blister packaging, packaging of electronic articles, foods and electrical capacitor films, obtainable from monofilms according to claims 1 to 10.
